(19) United States
(12) Patent Application Publication
(10) Pub. No.: US 2026/0226780 A1
(43) Pub. Date: Aug. 6, 2026

(54) HINGE WITH ADJUSTABLE BUFFER

(71) Applicant: Peiling LIANG, FOSHAN, GUANGDONG (CN)

(72) Inventor: Xian Poh ANG, FOSHAN, GUANGDONG (CN)

(73) Assignee: Peiling LIANG, FOSHAN, GUANGDONG (CN)

(21) Appl. No.: 18/847,422

(22) PCT Filed: Apr. 3, 2024
(86) PCT No.: PCT/CN2024/085934

§ 371 Date: Sep. 16, 2024

(30) Foreign Application Priority Data
Oct. 26, 2023 (CN) 202311407838.8
Feb. 7, 2024 (CN) 202410172662.0

(51) Int. Cl. E05F 5/06; E05F 5/00

(52) U.S. Cl. CPC E05F 5/06; E05F 5/006

(57) ABSTRACT

A hinge with adjustable buffer is disclosed, including a hinge cup, a hinge body, a hinge arm, a buffer, a hinge shaft, a housing guide sleeve and a shifting block; the housing guide sleeve is sleeved in the hinge body, the buffer is arranged in the housing guide sleeve, a limiting chute opening is arranged on the housing guide sleeve, and a limiting piece is arranged in the limiting chute opening; the shifting block is movably mounted on the hinge body, a limiting block is arranged at a bottom of the shifting block, and when the shifting block is moved along a lateral direction, the limiting block cooperates with the limiting piece for limiting movement of the buffer.

### CROSS-REFERENCE TO RELATED APPLICATION

This application is a national stage filing under 35 U.S.C. § 371 of international application number PCT/CN2024/085934, filed Apr. 3, 2024, which claims priority to Chinese patent applications No. 202311407838.8 filed Oct. 26, 2023 and No. 202410172662.0 filed Feb. 7, 2024. The contents of these applications are incorporated herein by reference in their entirety.

### TECHNICAL FIELD

The present disclosure relates to the technical field of furniture hardware, and more particularly, to a hinge with adjustable buffer.

### BACKGROUND

Hinge is a member used to connect a cabinet body and a cabinet door in traditional furniture hardware fittings. A buffering force of an existing buffering hinge is constant, which cannot be adjusted according to an actual use situation. However, users' home environments are complex, and various hinges with constant buffering force may not be suitable for the users. If the buffering force of the hinge is small, a heavy door will slam when it closes, and if the buffering force is too large, the closing process will take a long time. Therefore, it is urgent to further improve the existing hinge structure to be suitable for various places.

### SUMMARY

The present disclosure aims at solving at least one of the technical problems existing in the existing technology. Therefore, the embodiments of the present disclosure provide a hinge with adjustable buffer, which includes a hinge cup, a hinge body, a hinge arm, a buffer, a hinge shaft, a housing guide sleeve and a shifting block; the housing guide sleeve is sleeved in the hinge body, the buffer is mounted in the housing guide sleeve, the housing guide sleeve is provided with a limiting chute opening, the limiting chute opening is provided with a first position and a second position, and a limiting piece is arranged at the limiting chute opening; the shifting block is movably mounted on the hinge body, and a limiting block is arranged at a bottom of the shifting block; when the shifting block is shifted, the limiting block moves between the first position and the second position; when the limiting block moves to the second position, the limiting block cooperates with the limiting piece to limit movement of the buffer; and when the limiting block moves to the first position, the cooperation between the limiting block and the limiting piece is released, and the movement of the buffer is resumed.

The present disclosure has at least the following beneficial effects:

The buffer realizes a buffering function when the hinge is opened and closed, and the limiting block moves between the first position and the second position with the shifting of the shifting block. When the limiting block moves to the second position and the limiting block moves to the front side of the limiting piece, the movement of the buffer in the hinge body is limited, thereby limiting a buffering distance of the buffer and further reducing an opening and closing angle of the hinge; and when the limiting block moves away from the limiting piece along with the shifting of the shifting block, limiting om the movement of the buffer is released, thereby increasing the buffering distance of the buffer and further increasing the opening and closing angle of the hinge.

According to some embodiments of the present disclosure, the limiting piece is a limiting protrusion, and when the shifting block is moved in a lateral direction, the limiting block is moved to a front side of the limiting protrusion, or the limiting block is far away from the limiting protrusion.

According to some embodiments of the present disclosure, the limiting block is provided with a first inclined plane, the limiting protrusion is provided with a second inclined plane, and the first inclined plane cooperates with the second inclined plane.

According to some embodiments of the present disclosure, a bottom of the shifting block is provided with two clamping portions, and the two clamping portions are symmetrically arranged.

According to some embodiments of the present disclosure, the limiting piece is a limiting elastic sheet, and when the shifting block is moved in a lateral direction, the limiting block is pressed against the limiting elastic sheet and the limiting elastic sheet is released from abutting against the buffer, or the limiting block is far away from the limiting elastic sheet and the limiting elastic sheet is reset to abut against the buffer.

According to some embodiments of the present disclosure, the shifting block is also symmetrically provided with supporting plates, and the supporting plates are slidably mounted in the limiting chute opening.

According to some embodiments of the present disclosure, the supporting plates are provided with a protrusion, the hinge body is provided with a chute opening, an inner edge of the chute opening is provided with a recess, and the recess cooperates with the protrusion.

According to some embodiments of the present disclosure, the supporting plates include a first supporting plate and a second supporting plate, the first supporting plate is provided with a hook plate, the hook plate is used for hooking the hinge body, and the limiting block is arranged on the second supporting plate.

According to some embodiments of the present disclosure, two sides of the hinge body are provided with a first sliding block, two sides of the housing guide sleeve are provided with a second sliding block, and the second sliding block is arranged on a top surface of the first sliding block.

According to some embodiments of the present disclosure, the second sliding block is 7-shaped, the second sliding block includes a horizontal part and a vertical part, the horizontal part is slidably arranged on the first sliding block, and the vertical part blocks a front side of the first sliding block.

Additional aspects and advantages of the present disclosure will be set forth in part in the following description, and in part will be obvious from the following description, or can be learned by practice of the present disclosure.

### BRIEF DESCRIPTION OF THE DRAWINGS

The above and/or additional aspects and advantages of the present disclosure will be more apparent from the following description of certain preferred embodiments taken in conjunction with the accompanying drawings, where:

FIG. 1 is an overall schematic diagram according to a first embodiment of the present disclosure;

FIG. 2 is a schematic diagram I showing an overall sectional view according to the first embodiment of the present disclosure;

FIG. 3 is a schematic diagram showing a combined state of a housing guide sleeve and a shifting block according to the first embodiment of the present disclosure;

FIG. 4 is a schematic diagram II showing the overall sectional view according to the first embodiment of the present disclosure;

FIG. 5 is a schematic diagram of the housing guide sleeve according to the first embodiment of the present disclosure;

FIG. 6 is a schematic diagram of the shifting block according to the first embodiment of the present disclosure;

FIG. 7 is a schematic diagram I showing an overall sectional view according to a second embodiment of the present disclosure;

FIG. 8 is a schematic diagram II showing the overall sectional view according to the second embodiment of the present disclosure;

FIG. 9 is a schematic diagram III showing the overall sectional view according to the second embodiment of the present disclosure;

FIG. 10 is an enlarged schematic diagram of A in FIG. 3;

FIG. 11 is a schematic diagram III showing the overall sectional view according to the second embodiment of the present disclosure;

FIG. 12 is an enlarged schematic diagram of B in FIG. 5;

FIG. 13 is a schematic sectional diagram showing a combined state of the housing guide sleeve of a hinge body according to the second embodiment of the present disclosure;

FIG. 14 is a schematic diagram showing a combined state of the buffer and the housing guide sleeve according to the second embodiment of the present disclosure;

FIG. 15 is a schematic diagram of the hinge body according to the second embodiment of the present disclosure;

FIG. 16 is a schematic diagram of section C-C in FIG. 9;

FIG. 17 is a schematic diagram I of a shifting block according to the second embodiment of the present disclosure;

FIG. 18 is a schematic diagram II of the shifting block according to the second embodiment of the present disclosure;

FIG. 19 is a schematic sectional diagram showing a combined state of the housing guide sleeve and the shifting block according to the first embodiment of the present disclosure; and

FIG. 20 is a schematic sectional diagram showing the combined state of the housing guide sleeve and the shifting block according to the second embodiment of the present disclosure.

### DETAILED DESCRIPTION

The embodiments of the present disclosure will be described in detail hereinafter. Examples of the embodiments are shown in the accompanying drawings. The same or similar reference numerals throughout the drawings denote the same or similar elements or elements having the same or similar functions. The embodiments described below with reference to the accompanying drawings are exemplary and are intended to explain the present disclosure, but should not be construed as limiting the present disclosure.

In the description of the present disclosure, it shall be understood that the orientation or position relation related to the orientation description, such as the orientation or position relation indicated by the upper, lower, front, rear, left, right, etc., is based on the orientation or position relation shown in the drawings, which is only used for convenience of description of the present disclosure and simplification of description instead of indicating or implying that the indicated device or element must have a specific orientation, and be constructed and operated in a specific orientation, and thus shall not be understood as a limitation to the present disclosure.

In the description of the present disclosure, the meaning of multiple refers to be more than two. The meanings of greater than, less than, more than, etc., are understood as not including this number. If there is a description to the first and second, it is only for the purpose of distinguishing technical features, and shall not be understood as indicating or implying relative importance, implicitly indicating the number of the indicated technical features or implicitly indicating the order of the indicated technical features.

In the description of the present disclosure, unless otherwise explicitly defined, words such as setting, mounting and connecting should be understood in a broad sense, and those skilled in the art can reasonably determine the specific meanings of the above words in the present disclosure, in combination with the specific contents of the technical solutions.

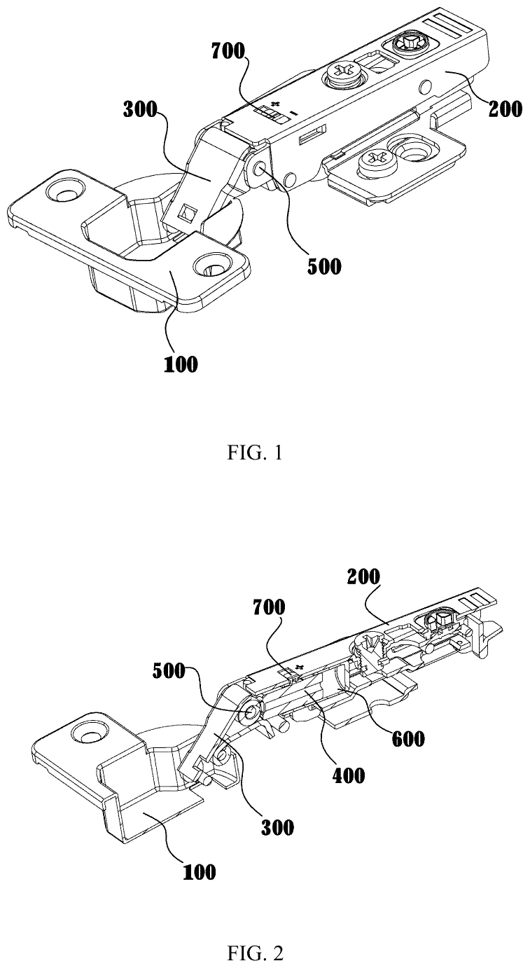

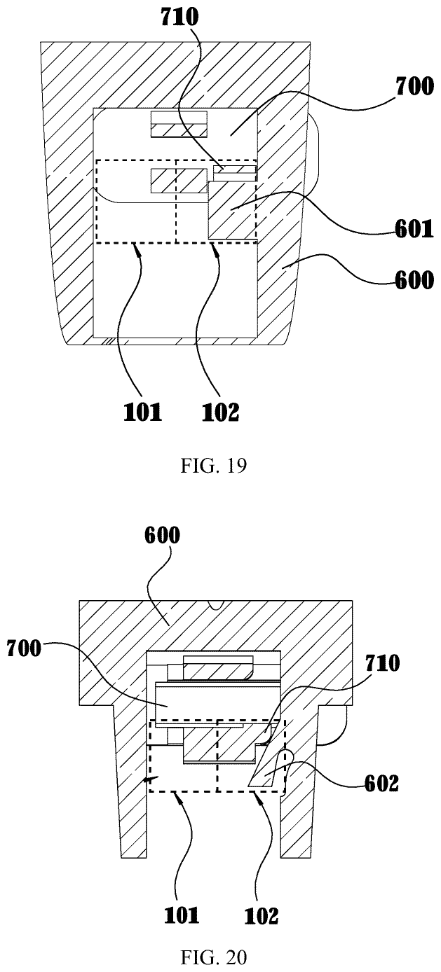

Referring to FIGS. 1, 7, 19 and 20, a hinge with adjustable buffer includes a hinge cup 100, a hinge body 200, a hinge arm 300, a buffer 400, a hinge shaft 500, a housing guide sleeve 600 and a shifting block 700. The housing guide sleeve 600 is sleeved in the hinge body 200, the buffer 400 is mounted in the housing guide sleeve 600, the housing guide sleeve 600 is provided with a limiting chute opening 610, the limiting chute opening 610 is provided with a first position 101 and a second position 102, and a limiting piece is arranged at the limiting chute opening 610. The shifting block 700 is movably mounted on the hinge body 200, and a limiting block 710 is arranged at a bottom of the shifting block 700. When the shifting block 700 is shifted, the limiting block 710 moves between the first position 101 and the second position 102; when the limiting block 710 moves to the second position 102, the limiting block 710 cooperates with the limiting piece to limit movement of the buffer 400; and when the limiting block 710 moves to the first position 101, the cooperation between the limiting block 710 and the limiting piece is released, and the movement of the buffer 400 is resumed.

The buffer realizes a buffering function when the hinge is opened and closed, and the limiting block 710 moves between the first position 101 and the second position 102 with the shifting of the shifting block 700. When the limiting block 710 moves to the second position 102 and the limiting block 710 moves to the front side of the limiting piece, the movement of the buffer 400 in the hinge body 200 is limited, thereby limiting a buffering distance of the buffer 400 and further reducing an opening and closing angle of the hinge; and when the limiting block 710 moves away from the limiting piece along with the shifting of the shifting block 700, limiting on the movement of the buffer 400 is released, thereby increasing the buffering distance of the buffer 400 and further increasing the opening and closing angle of the hinge.

Referring to FIGS. 1 and 2, in a first embodiment, the housing guide sleeve 600 is mounted in the hinge body 200, the buffer 400 is mounted in the housing guide sleeve 600, the limiting chute opening 610 is provided in the housing guide sleeve 600, and the limiting protrusion 601 is provided in the limiting chute opening 610. The shifting block 700 is movably mounted on the hinge body 200, the limiting block 710 is arranged at the bottom of the shifting block 700, and when the shifting block 700 is moved in the lateral direction, the limiting block 710 moves to the front side of the limiting protrusion 601, or the limiting block 710 is far away from the limiting protrusion 601.

The buffer 400 has the buffering function when the hinge is opened and closed, when the limiting block 710 moves to the front of the limiting protrusion 601 with the shifting of the shifting block 700, the movement of the buffer 400 in the hinge body 200 is limited, thereby limiting the buffering distance of the buffer 400 and further reducing the opening and closing angle of the hinge. When the limiting block 710 moves away from the limiting protrusion 601 along with the shifting of the shifting block 700, the limiting on the movement of the buffer 400 is released, thereby increasing the buffering distance of the buffer 400 and further increasing the opening and closing angle of the hinge. The hinge can freely control the opening and closing angle thereof, which can meet control requirements of different opening and closing angles.

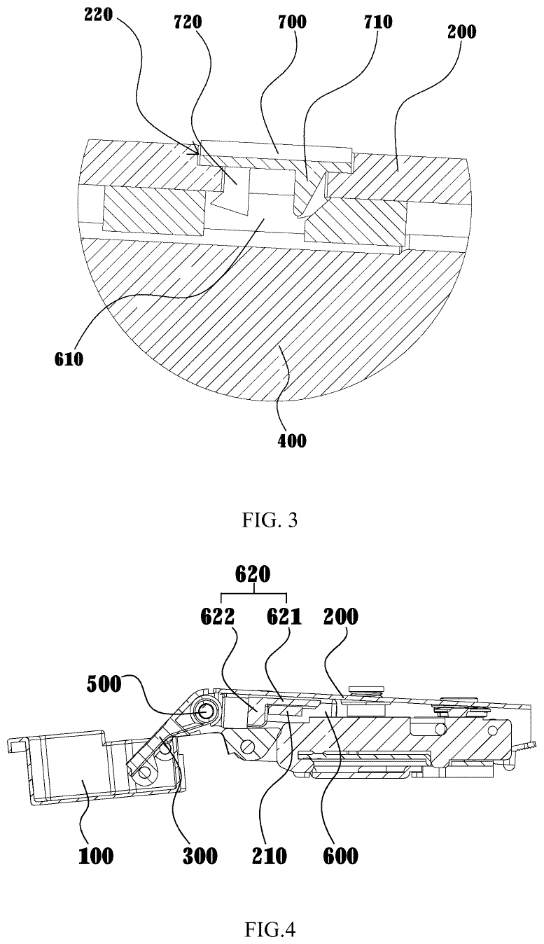

Referring to FIGS. 3 and 6, the limiting chute opening 610 is arranged at a top of the hinge body 200, and the shifting block 700 is slidably mounted in the limiting chute opening 610. In order to prevent the shifting block 700 from escaping from the chute opening 220 arranged in the hinge body 200, two clamping portions 720 are arranged symmetrically at a bottom of the shifting block 700, and the clamping portions 720 are hooked on two sides of a bottom of the chute opening 220 without affecting the movement of the shifting block 700 in the limiting chute opening 610.

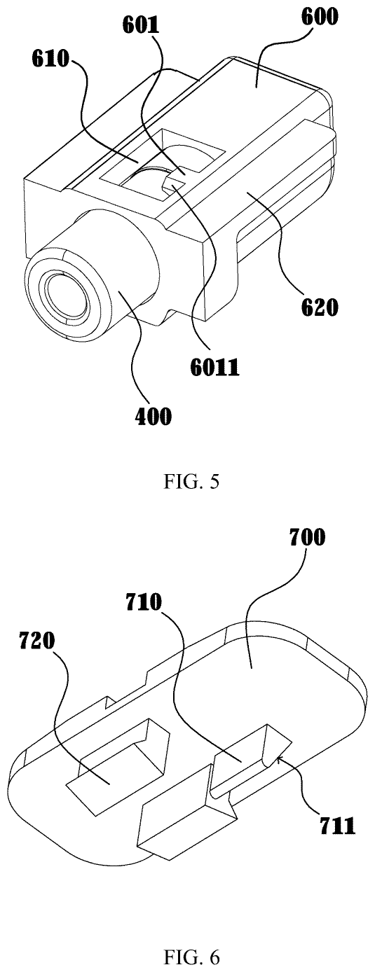

Referring to FIGS. 4 and 5, two sides of the hinge body 200 are provided with a first sliding block 210, two sides of the housing guide sleeve 600 are provided with a second sliding block 620, and the second sliding block 620 is arranged on a top surface of the first sliding block 210 to ensure stable movement of the housing guide sleeve 600 in the hinge body 200.

Specifically, the second sliding block 620 is 7-shaped, the second sliding block 620 includes a horizontal part 621 and a vertical part 622, the horizontal part 621 is slidably arranged on the first sliding block 210, and the vertical part 622 blocks a front side of the first sliding block 210 to limit movement of the first sliding block 210 through the vertical part 622.

Referring to FIGS. 5 and 6, in this embodiment, the limiting block 710 is provided with a first inclined plane 711, the limiting protrusion 601 is provided with a second inclined plane 6011, and the first inclined plane 711 cooperates with the second inclined plane 6011, so that the limiting block 710 and the limiting protrusion 601 are matched.

Specifically, in this embodiment, the limiting chute opening 610 is concave, so that the limiting block 710 can move laterally and longitudinally in the limiting chute opening 610.

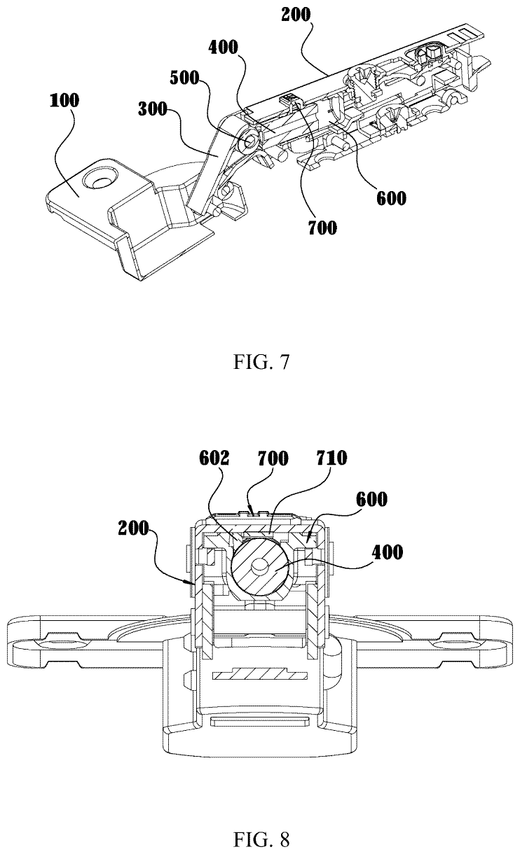

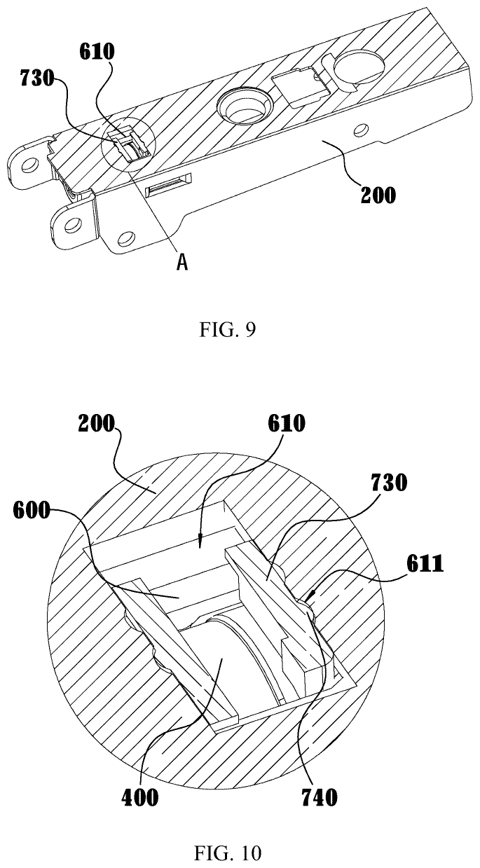

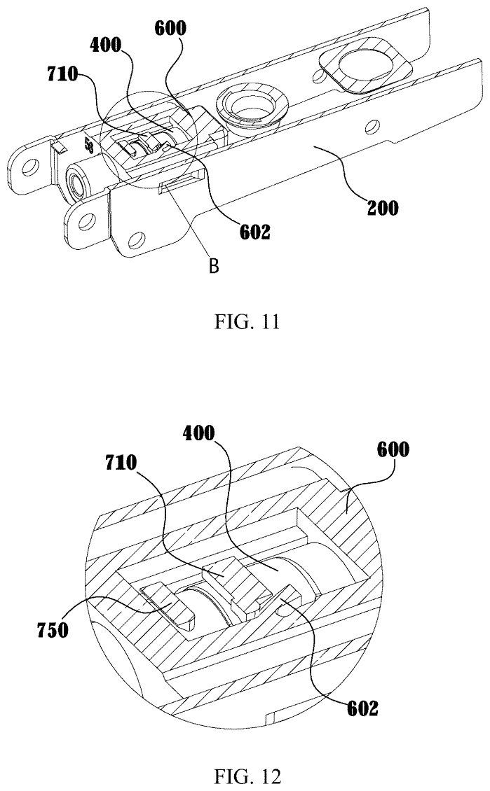

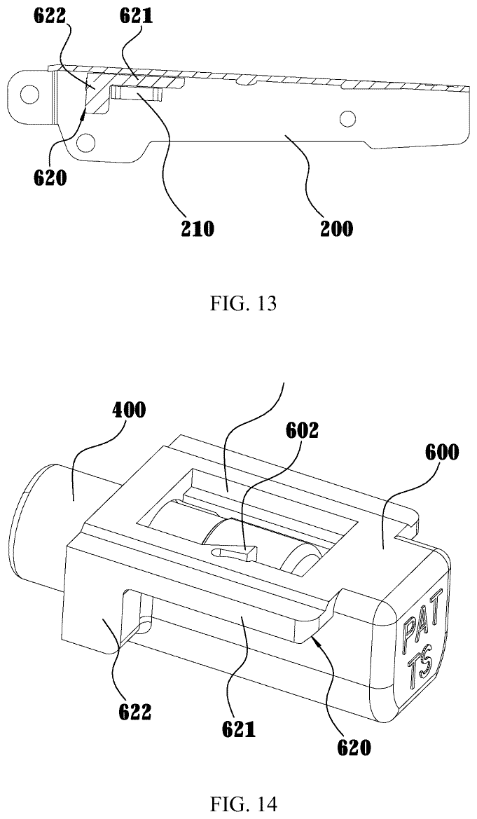

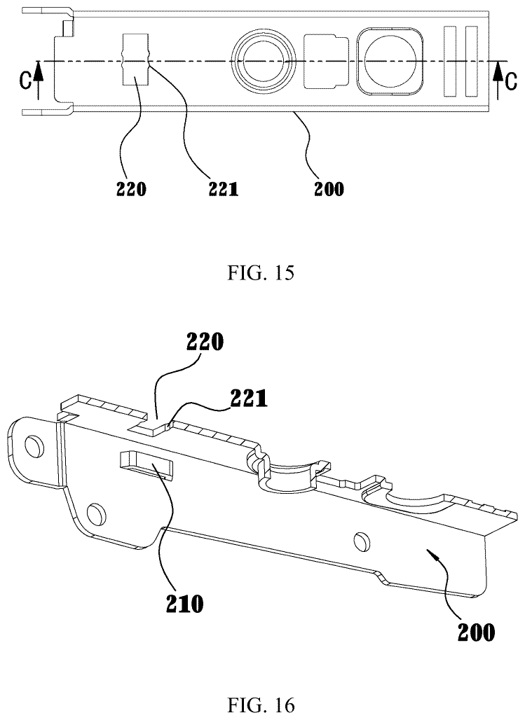

Referring to FIGS. 7, 11 and 12, in a second embodiment, the housing guide sleeve 600 is mounted in the hinge body 200, the buffer 400 is mounted in the housing guide sleeve 600, and a limiting elastic sheet 602 is arranged on the housing guide sleeve 600. The limiting elastic sheet 602 is used for abutting against the buffer 400, so that the movement of the buffer 400 is limited. The shifting block 700 is movably mounted on the hinge body 200, and the limiting block 710 is arranged at the bottom of the shifting block 700. When the shifting block 700 is moved in the lateral direction, the limiting block 710 is pressed against the limiting elastic sheet 602 and the limiting elastic sheet 602 is released from abutting against the buffer 400, or the limiting block 710 is far away from the limiting elastic sheet 602 and the limiting elastic sheet 602 is reset to abut against the buffer 400.

The buffer 400 has a buffering effect when the hinge is opened and closed, when the shifting block 700 is moved in the lateral direction, the limiting block 710 is far away from the limiting elastic sheet 602, and the limiting elastic sheet 602 is reset to abut against the buffer 400, thereby reducing the opening and closing angle of the hinge; when the limiting block 710 is pressed against the limiting elastic sheet 602, the elastic sheet 602 is released from abutting against the buffer 400, limiting on the movement of the buffer is released, thereby increasing the buffer distance of the buffer and further increasing the opening and closing angle of the hinge.

Referring to FIGS. 10, 17 and 18, the top of the hinge body 200 is provided with the chute opening 220, and the shifting block 700 is also symmetrically provided with supporting plates 730, and the supporting plates 730 are slidably mounted in the limiting chute opening 220.

At the same time, the supporting plates 730 are provided with a protrusion 740, the hinge body 200 is provided with a chute opening 220, an inner edge of the chute opening 220 is provided with a recess 221, and the recess 221 cooperates with the protrusion 740.

Specifically, there are two recesses 221. When a user shifts the shifting block 700, the protrusion 740 will slide into the two recesses 221 in turn to remind the user that a current working action of the shifting block 700 is in place, and the two recesses 221 respectively correspond to two working actions of the limiting block 710:
the first working action is that the limiting block 710 presses against the limiting elastic sheet, and the limiting elastic sheet 602 is released to abut against the buffer 400; and
the second working action is that the limiting block 710 is far away from the limiting elastic sheet 602, and the limiting elastic sheet 602 is reset to abut against the buffer 400.

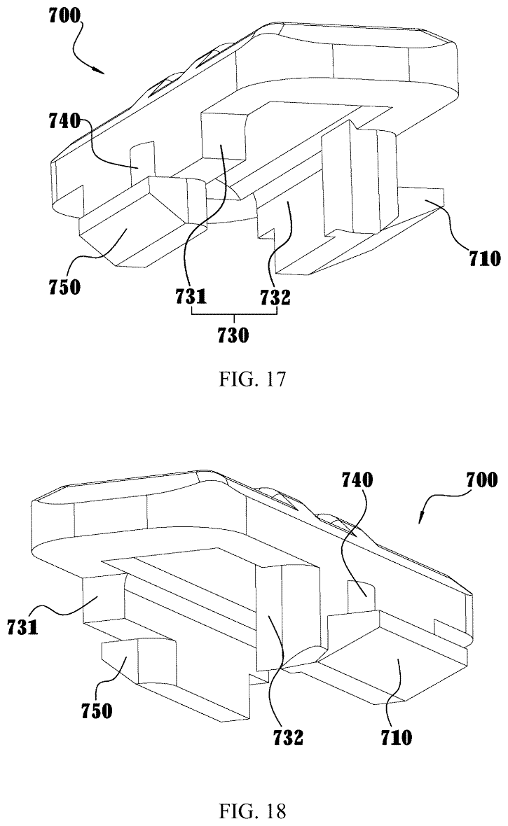

Referring to FIGS. 17 and 18, specifically, the supporting plates 730 include a first supporting plate 731 and a second supporting plate 732. The first supporting plate 731 is provided with a hook plate 750, the hook plate 750 is used for hooking the hinge body 200 to present the shifting block 700 from escaping from the limiting chute opening 610. At the same time, the second supporting plate 732 is provided with a limiting block 710.

The chute opening 220 is arranged at the top of the hinge body 200, and the shifting block 700 is slidably inserted into the chute opening 220. In order to prevent the shifting block 700 from escaping from the chute opening 220, two supporting plates 730 are arranged symmetrically at the bottom of the shifting block 700, and the supporting plates 730 are hooked on two sides of the bottom of the chute opening 220 without affecting the movement of the shifting block 700 in the chute opening 220.

In the description of the specification, the descriptions of the reference terms “some embodiments”, or “it is conceivable that”, etc. refer to that the specific features, structures, materials characteristics described in combination with the embodiment or example are included in at least one embodiment or example of the present disclosure. In the specification, the schematic representation of the above terms does not necessarily mean the same embodiment or example. Moreover, the specific features, structures, materials or characteristics described can be combined in any one or more embodiments or examples in a suitable manner.

The embodiments of the present disclosure have been described in detail with reference to the drawings, but the present disclosure is not limited to the above embodiments, and various changes can be made within the knowledge of those of ordinary skills in the art without departing from the objectives of the present disclosure.

1. A hinge with adjustable buffer, comprising a hinge cup, a hinge body, a hinge arm, a buffer and a hinge shaft, wherein the hinge with adjustable buffer further comprises:
a housing guide sleeve, wherein the housing guide sleeve is mounted in the hinge body, the buffer is mounted in the housing guide sleeve, the housing guide sleeve is provided with a limiting chute opening, and a limiting piece is arranged at the limiting chute opening; and
a shifting block, wherein the shifting block is movably mounted on the hinge body, a limiting block is arranged at a bottom of the shifting block, the limiting block is movable between a first position and a second position while the shifting block is shifted, when the limiting block moves to the second position, the limiting block cooperates with the limiting piece to limit movement of the buffer, and when the limiting block moves to the first position, the cooperation between the limiting block and the limiting piece is released, and the movement of the buffer is resumed.

2. The hinge with adjustable buffer according to claim 1, wherein the limiting piece is a limiting protrusion, and when the shifting block is moved in a lateral direction, the limiting block is moved to a front side of the limiting protrusion, or the limiting block is far away from the limiting protrusion.

3. The hinge with adjustable buffer according to claim 2, wherein the limiting block is provided with a first inclined plane, the limiting protrusion is provided with a second inclined plane, and the first inclined plane cooperates with the second inclined plane.

4. The hinge with adjustable buffer according to claim 2, wherein a bottom of the shifting block is provided with two clamping portions, and the two clamping portions are symmetrically arranged.

5. The hinge with adjustable buffer according to claim 1, wherein the limiting piece is a limiting elastic sheet, and when the shifting block is moved in a lateral direction, the limiting block is pressed against the limiting elastic sheet and the limiting elastic sheet is released from abutting against the buffer, or the limiting block is far away from the limiting elastic sheet and the limiting elastic sheet is reset to abut against the buffer.

6. The hinge with adjustable buffer according to claim 1, wherein the shifting block is symmetrically provided with supporting plates, and the supporting plates are slidably mounted in the limiting chute opening.

7. The hinge with adjustable buffer according to claim 6, wherein the supporting plates are provided with a protrusion, the hinge body is provided with a chute opening, an inner edge of the chute opening is provided with a recess, and the recess cooperates with the protrusion.

8. The hinge with adjustable buffer according to claim 6, wherein the supporting plates comprises a first supporting plate and a second supporting plate, the first supporting plate is provided with a hook plate, the hook plate is used for hooking the hinge body, and the limiting block is arranged on the second supporting plate.

9. The hinge with adjustable buffer according to claim 1, wherein two sides of the hinge body are provided with a first sliding block, two sides of the housing guide sleeve are provided with a second sliding block, and the second sliding block is arranged on a top surface of the first sliding block.

10. The hinge with adjustable buffer according to claim 9, wherein the second sliding block is 7-shaped, the second sliding block comprises a horizontal part and a vertical part, the horizontal part is slidably arranged on the first sliding block, and the vertical part blocks a front side of the first sliding block.
